(19) United States
(12) Patent Application Publication
(10) Pub. No.: US 2026/0114958 A1
(43) Pub. Date: Apr. 30, 2026

(54) REAL-TIME AUTOMATED TREATMENT RECOMMENDATIONS FOR DIGITAL DENTAL TREATMENT PLANNING AND DENTAL APPLIANCE DESIGN

(71) Applicant: Align Technology, Inc., San Jose, CA (US)

(72) Inventors: Mitra DERAKHSHAN, Herndon, VA (US); Jeeyoung CHOI, Sunnyvale, CA (US); Che-Jui LIAO, San Jose, CA (US)

(21) Appl. No.: 19/376,805

(22) Filed: Oct. 31, 2025

Related U.S. Application Data
(60) Provisional application No. 63/714,812, filed on Oct. 31, 2024.

(51) Int. Cl. A61C 7/00; A61C 9/00; A61C 13/34

(52) U.S. Cl. CPC A61C 7/002; A61C 9/0053; A61C 13/34

(57) ABSTRACT

Methods and apparatuses for performing an intraoral scan may analyzing and determine, in real time as the scan is occurring or immediately thereafter, one or more treatments based on the scan data, as well as patient-specific data and/or personalized doctor preferences. For example, these methods and apparatuses may be configured to detect one or more treatable orthodontic issues while scanning the patient and propose treatments (including orthodontic appliances) by calculating one or more metrics from the ongoing scan that indicate the need for particular treatments (e.g., interventions).

### CLAIM OF PRIORITY

This application claims priority to U.S. Patent Application No. 63/714,812, filed Oct. 31, 2024, entitled, “TREATMENT RECOMMENDATIONS BASED ON INTRAORAL SCANNING,” herein incorporated by reference in its entirety, as if set forth fully herein.

### INCORPORATION BY REFERENCE

All publications and patent applications mentioned in this specification are herein incorporated by reference to the same extent as if each individual publication or patent application was specifically and individually indicated to be incorporated by reference.

### BACKGROUND

A general practitioner (“GP) or pediatric dentist may intraorally scan a child or teen's dentition, which may occur during routine oral care or record taking. When scanning the dentition, the GP or dentist may not necessarily be thinking about or considering orthodontic treatment for the patient, or aware that a patient may benefit from one or more treatments. There may be a benefits for a GP or dentist to be informed of or made aware of possible orthodontic treatment options based on the dentition scan performed as part of an oral care office visit.

Additionally, orthodontists may intraorally scan a patient's dentition and determine an orthodontic treatment option based primarily on their professional subjective assessment.

There may be benefits for an orthodontist to be informed of an automated recommended treatment that they would not have access to during the intraoral scan, which may allow them to make a more informed treatment decision and improve their level of patient care.

Additionally, there may be benefits to visualizing a possible orthodontic treatment based on an intraoral scan of a patient's dentition.

### SUMMARY OF THE DISCLOSURE

The disclosure is related to orthodontic treatment recommendations based at least on an intraoral scan of a patient's dentition. As an example, methods and apparatuses (including systems) may provide one or recommendations chairside in real time, while the scan is being performed and/or shortly (e.g., within minutes) thereafter. While the disclosure herein may provide particular benefits for pediatric dentists, GPs and orthodontists, the disclosure herein may be applicable to any patient receiving dental and/or orthodontic care or attention.

Many of these advantages and benefits may be realized because of the use of a techniques (implemented in software, hardware and/or firmware) for identifying specific features from the three-dimensional (3D) scan, and/or one or more feature index(es) that may be configured specifically for rapid and accurate analysis to assist in coordinating identified features with likely clinical recommendations. As will be described in greater detail herein, these features may be selected specifically to provide a high degree of accuracy in predicting beneficial treatments. Any of these methods and apparatuses may include the use of one or more trained machine learning agent(s) to identify features from the 3D scan(s) and/or to identify one or more treatment(s) using the features and a feature index. In some cases the feature index may be modified, updated, maintained, and/or created by the same or a different machine learning agent.

In general, these method may be used to determine one or more treatment recommendations in real or near-real time, and/or to automatically or semi-automatically populate treatment and/or prescription forms. Alternatively or additionally, these methods and apparatuses may be configured to generate one or more treatment plans for the patient incorporating the treatment recommendations, and/or generating one or more dental appliances to perform the treatment recommendations.

One of the benefits of the disclosure herein is that one or more of pediatric dentists, general practitioners, or orthodontists may be more informed or more fully informed about recommended orthodontic treatments, which can lead to better patient outcomes. The benefits include information that would not otherwise have been presented, provided, or accessible to the care team based on the intraoral scan. For example, GPs and dentists may perform intraoral scans of patient's dentitions (e.g., children or teens) as part of routine oral care and/or record taking. However, GPs and dentists may not necessarily be considering or aware of possible orthodontic treatment based on the intraoral scan and/or their own subject assessment. Intraoral scanning systems herein are adapted to predict a recommend treatment movement of one or more of the patient's teeth based on the intraoral scan and recommend an oral treatment to the care provider based on the recommended treatment movement. This is an improvement in technology for the care provider, in that the system provides information in the form of predicted recommended teeth movement and/or recommended oral treatment to the care provider.

Additionally, for example, orthodontists may currently scan a patient's dentition using an intraoral scanner and determine an orthodontic treatment based on their subject assessment, based primarily on personal experience. There may be benefits for the orthodontist to be informed of a recommended treatment that they would not typically have access to or be aware of, which may allow them to make a more informed treatment decision. Intraoral scanning systems herein may be adapted to predict a recommended treatment movement of one or more of the patient's teeth based on the intraoral scan and recommend an oral treatment to an orthodontist based on the recommended treatment movement. And while an orthodontist may feel comfortable in their subjective assessment based on their expertise, the recommended treatments herein provides them with information they otherwise would not have access to, allowing them to make a more fully informed decision or diagnosis about treatment, and/or allowing them to make more informed decisions and potentially providing better patient outcomes.

One benefit of the innovations described herein is that the treatment recommendations can help general practitioners (GPs) and/or pediatric dentists realize or better realize the need for early Phase 1 treatment during their routine practice and/or consider moving onto orthodontic treatment using dental aligners and/or palatal expanders.

In one aspect, an intraoral scanning system, or at least a portion of the system, is adapted to provide a treatment recommendation to the patient care team (e.g., pediatric dentist, general practitioner, orthodontist) based on at least an intraoral scan of the subject's dentition, which may occur real-time or near real-time with when the intraoral scan in performed. These methods and apparatuses may also advantageously assist in preparing (e.g., pre-populating) prescription/treatment forms.

As mentioned, these methods and apparatuses may provide real time analysis and recommendations of the patient's dentition, as the scan is being performed. While scanning (including immediately after scanning) the apparatus (e.g., system, device, etc.) may accumulate one or more, preferably a plurality of, measurements of features of the patient's teeth. These measurements may be estimated continuously or periodically during the scan (e.g., at a frequency of greater than 0.01 Hz, 0.1 Hz, 0.5 Hz, 1 Hz, 1.5 Hz, 2 Hz, 3 Hz, 4 Hz, 5 Hz, 10 Hz, 20 Hz, etc.). At the start of a scan, insufficient data may be available to measure these features; the apparatus or methods may accumulate predetermined features (and may update/correct them) until a confidence threshold for all or some of the features is met or exceeded, indicating that the feature is likely sufficiently reliable to make a prediction, as described herein, even before the scan has completed. Features may include measurements of individual teeth and/or relationships between teeth, and/or deviations from optimal/expected configurations of the arrangements of teeth, etc. For example features may include, but are not limited to, intramolar width, anterior-posterior (A-P) distance, tooth rotational position, tilting of one or more teeth, spacing/gaps between teeth, estimates of intercuspation, tooth shape, etc.

The methods and apparatuses described herein provide a technical solution to the technical problems associated with dental/orthodontic case, including problems associated with enhancing the accuracy and speed of clinical care by providing rapid and accurate analysis of patient teeth in real time, as well as the problem of identifying features that may indicate orthodontic (often complex) orthodontic problems and likely treatments. These methods may allow for immediate patient and/or clinician (e.g., orthodontist) feedback, which allows for immediate refinement of the intraoral scan. Previously, the analysis of intraoral scan data required post-scan analysis and resulted in slower and less dynamic treatment.

For example described herein are methods of determining, in real time, one or more interventions while scanning a patient's dentition. Any of these methods may include: scanning the patient's dentition with an intraoral scanner; generating (in some cases while scanning) a three-dimensional (“3D”) model of the patient's dentition; measuring (in some cases while scanning) one or more features of the 3D model of the patient's dentition; calculating a recommended treatment of one or more of the patient's teeth based at least on the measured one or more features and a feature index based on patient-specific data; and outputting the recommended treatment. A “feature index,” as used herein, can include a measure used to quantify one or more features related to assessing, monitoring, assisting in diagnosing, and/or treating a condition. Examples of feature indices can include indices that relate attributes of a specific patient's dentition and/or demographic and/or other patient historical factors for a specific patient to cases in databases of historical and/or modeled treatments. Examples of attributes of a specific patient's dentition include anatomical measurements such as oral cavity depth(s), oral cavity width(s), shape and/or color of soft tissue, physical attributes of crowns, roots, and/or other tooth portions. Examples of demographic and/or other patient historical factors for a specific patient include patient age, family history, patient geography, patient ethnicity, patient gender, patient lifestyle, etc.

“Patient-specific data,” as used herein, can include any information unique to an individual patient's health, diagnosis, and/or treatment. In some implementations, patient-specific data is collected and/or stored in health records, e.g., electronic health records and forms the basis of one or more decisions about a patient's care. Examples of patient-specific data can include demographic data, clinical data, treatment information, and/or other patient-generated health data (e.g., health information created, recorded, and/or gathered by patients using devices associated with the patients). Patient-specific data may include attributes of a specific patient's dentition and/or demographic and/or other patient historical factors for a specific patient.

In some implementations, the systems and methods herein implement one or more automated (or semi-automated, including user-assisting) processes that evaluate patient-specific data against treatment parameters inferred from general treatment data. General treatment data can include information from past and/or hypothetical treatments. General treatment data can include real treatment data and/or synthetic treatment data. General treatment data can further include information from historical treatments (e.g., information from past cases where people have been treated), information from modeled treatments (e.g., synthetic information from simulations of treatments), etc.

Historical treatment information, as used herein, can include data related to actual patients who have undergone treatment for one or more conditions. Examples of historical treatment information can include pre-treatment, post-treatment, and intermediate-treatment attributes of dentition of patients who have undergone treatment for a condition. For the example of dentition treatment, examples of historical treatment information can include anatomical measurements of oral cavities and how these anatomical measurements have changed through the course of historical treatments. Additional examples of historical treatment information can include demographic and/or other patient historical factors associated with historical treatments. Modeled treatment information, as used herein, can include data related to hypothetical or real patients for whom treatment for one or more conditions has been simulated. Examples of modeled treatment information can include pre-treatment, post-treatment, and intermediate-treatment attributes of dentition of hypothetical or real patients for whom treatment has been simulated. For example, dentition treatment, examples of modeled treatment information can include anatomical measurements of oral cavities and how these anatomical measurements are simulated to have changed through the course of simulated treatments. Additional examples of modeled treatment information can include demographic and/or other patient historical factors associated with simulated treatments. Historical treatment data may be categorized (and these categories used for training and/or selection) based on patient population (age, gender, body size, body type, genetic background, etc.).

Treatment data, including information from historical and/or modeled treatments can be stored as structured data representing dentition attributes, historical factors, and/or other information related to historical and/or modeled treatments.

The systems and methods herein can implement one or more automated (or semi-automated) processes that evaluate one or more patient-specific features against patterns in general treatment data, wherein the feature index comprises a measure to infer a relationship between the patient-specific features and one or more patterns in the general treatment data.

In some implementations, automated processes implement an automated tabular classification system trained to evaluate a feature index and/or patient-specific data against patterns of information related to historical and/or modeled treatments. A tabular classification system can include one or more machine learning models to predict discrete treatment classifications for an instance of structured and/or tabular, data. In some implementations, tabular data can be organized in a tabular format with one dimension representing individual instances and another dimension representing different features or attributes. A tabular classification system can learn to classify new data based on patterns it discovers in a training dataset that contains examples of input features and their corresponding class labels. In various implementations, a tabular classification system can implement one or more decision determinations to evaluate a feature index and/or patient-specific data against patterns of information related to treatment data. A “decision determination,” as used herein, can include an automated learning process implemented to predict one or more outcomes related to patterns of information related to historical and/or modeled treatments. In some implementations, decision determinations are supervised. An example of a decision determination can include a decision tree, including, for instance, one or more classification trees to predict categorical outcomes based on attributes of a specific patient's dentition and/or demographic and/or other patient historical factors for a specific patient, regression trees to predict continuous numerical values based on attributes of a specific patient's dentition and/or demographic and/or other patient historical factors for a specific patient, etc. In some implementations, a tabular classification system is trained to recognize factors such as: (a) arch length, (b) arch depth, (c) intermolar width, (d) inter bicuspid width, (e) inter-canine width (f) patient demographic, (g) shape and color of soft tissue (e.g., for recession how deep gingival line is, shape of tooth image), (h) crown height increase because of gum recession, (i) puffy gum: anatomical form of gingival, thickness of gingiva, color, volume, level and location, tactile, etc.

Tabular classification systems can include, by way of example and not limitation: tree-based ensembles like gradient boosting (e.g., XGBoost, LightGBM), deep learning models (e.g., TabNet), tree-based models, methods like Random Forest, XGBoost, LightGBM, and CatBoost are widely used and highly effective for capturing complex interactions in tabular data, Deep learning models, such as TabNet and/or models using sequential attention to focus on different features at each step, Automated Machine Learning (AutoML) (e.g., systems to automate parts of the machine learning pipeline, such as model selection and hyperparameter tuning, making advanced techniques more accessible.).

The recommended treatment may be output in any appropriate manner. In some examples the output may comprise modifying the functioning of the operation of the intraoral scanner, including but not limited to displaying the recommended treatment on the intraoral scanner. For example, outputting may comprise visually presenting the recommended treatment on a display in communication with the intraoral scanner, in an electronic prescription form, treatment planning systems, doctor systems, or some combination thereof. Visually presenting the recommended treatment may comprise visually presenting at least one of a recommended lateral expansion, a recommended Anterior-Posterior (A-P) movement, or a recommended vertical movement. In some cases visually presenting the recommended treatment may comprise visually presenting a one or more factors for the recommended treatment.

Presenting recommended treatment may include providing recommended treatment(s) to a treatment and/or prescription form, including an electronic prescription form. An “electronic prescription form,” as used herein, can include a digital representation of a process through which a treatment provider electronically generates a prescription to a treatment professional. An electronic prescription form can include one or more treatment protocols used to treat a condition. Examples of treatment protocols include specific measures of transverse expansion, specific measures of mesial-distal movement, determinations of how to stage teeth through the course of orthodontic treatment, determinations of correcting soft tissue conditions, etc. An electronic prescription form can be implemented on a secure treatment planning platform, e.g., one supported by a treatment planning system and/or doctor system. For instance, an electronic prescription form may be protected by hardware, software, and/or permission-based security measures to ensure data in the electronic prescription form is inaccessible to unauthorized entities. Treatment planning platforms can further include measures to ensure transmission of an electronic prescription form is secure. In some implementations, an electronic prescription form can be relayed by a treatment provider to an entity that implements a treatment plan and/or manufactures appliances to implement a treatment plan. For instance, an electronic prescription form can be relayed by a treatment provider to an entity that implements orthodontic, restorative, and/or other dental treatment plans and/or manufactures appliances (aligners, retainers, palatal expanders, etc.) to implement an orthodontic, restorative, and/or dental treatment plan.

In various implementations, providing recommended treatment(s) to an electronic prescription form can include extracting one or more treatment parameters that are sufficiently similar, based on a feature index, to historical and/or modeled treatments. Extracted treatment parameters can pre-populate at least portions of an electronic prescription form. Providing recommended treatment(s) to an electronic prescription form can include feeding diagnostic insights into an electronic prescription form. For instance, if a treatment planning professional had a clinical insight related to transverse expansion, providing recommended treatment(s) to an electronic prescription form can include a suggested arch width and/or (a) aligners with arch expansion, and/or (b) a series of palatal expanders to expand the patient's palate. As another example, if a treatment planning professional had a clinical insight related to mesial-distal correction, providing recommended treatment(s) to an electronic prescription form can include a recommendation for Class II or Class III correction, specific distances of mesial-distal correction, and/or recommendations for aligners with buccal and/or occlusal blocks.

An electronic prescription form pre-populated with information from extracted treatment parameters can be presented to a treatment professional in treatment management software. In some implementations, suggested treatments (movements, expansions, staging patterns, locations of orthodontic attachments, stages to perform procedures (e.g., interproximal reduction (IPR)), ways to treat soft tissue, etc.) are presented in an electronic prescription form. A treatment professional can have options to accept, modify, and/or override suggested treatments. In some implementations, a treatment professional can approve suggested treatments in an electronic prescription form.

In any of these methods and apparatuses, measuring may comprise accumulating measurements of expected features while scanning the patient's dentition and wherein calculating comprises calculating once the accumulated measurements exceeds a confidence threshold. Any of these methods and apparatuses may include outputting a simulation of treatment that includes the recommended treatment.

As mentioned above, calculating the recommended treatment may be based on at least the measured one or more features and a feature index based on patient-specific data. In general, the feature index may be based on patient-specific data comprising one or more of: patient age, patient growth status, a predetermined treatment plan for the patient, and/or patient gender. For example, the feature index may be based on whether or not lower arch expansion is planned for the patient. In some cases calculating the recommended treatment comprises calculating a greater degree of recommended treatment movement when lower arch expansion is planned for the patient compared to when lower arch expansion is not planned for the patient.

In some examples the recommended treatment movement may comprise upper lateral expansion, and the recommended treatment movement comprises a greater degree of recommended upper lateral expansion when lower arch expansion is planned compared to when lower arch expansion is not planned for the patient. In general, calculating the recommended treatment may comprise basing the recommended treatment at least partially on one or more doctor-specific factors comprising one or more doctor treatment preferences.

Any of these methods and apparatuses may provide a justification or reasoning for the recommended treatment plan, and/or the supporting data. For example, outputting the recommended treatment may comprise providing a reasoning for the recommended treatment. The reasoning may be viewable upon user activation of a display screen interface, allowing the user to view or not view the reasoning.

In any of these examples measuring one or more features of the 3D model may comprise measuring one or more of: upper first molar arch width, upper second premolar arch width, upper first premolar arch width, upper arch depth width ratio, lower first molar arch width, arch shape, or degree of upper crowding.

Any of these methods and apparatuses may use a trained machine learning agent. The trained matching learning agent may be an artificial intelligence agent. The machine learning agent may be a deep learning agent. In some examples, the trained machine learning agent may be trained neural network. Any appropriate type of neural network may be used, including generative neural networks. The neural network may be one or more of: perceptron, feed forward neural network, multilayer perceptron, convolutional neural network, radial basis functional neural network, recurrent neural network, long short-term memory (LSTM), sequence to sequence model, modular neural network, etc. In some examples the trained machine learning agent may be trained using a training data set.

Calculating the recommended treatment may comprise inputting the one or more features into a model trained to receive as input the one or more features and predict the recommended treatment movement. In some examples, calculating the recommended treatment comprises calculating at least one of a recommended lateral expansion of the one or more of the patient's teeth, a recommended movement in an Anterior-Posterior (A-P) direction of the one or more teeth, or a recommended movement in a vertical direction of the one or more of the patient's teeth. For example, calculating the recommended treatment of the one or more of the patient's teeth may comprise calculating a recommended lateral expansion of the one or more of the patient's teeth. In any of these methods and apparatuses, outputting the recommend treatment comprises outputting at least one of a recommended inter-arch treatment width between first and second teeth, or an amount of recommended lateral expansion between the first and second teeth relative to a current inter-arch width based on the intraoral scan. The first and second teeth may comprise one or more of upper first molars, upper second premolars, or upper first premolars.

Any of these methods and apparatuses may include outputting (in some cases, as part of the recommend treatment) a treatment device recommendation based on the recommended treatment. For example, recommending the treatment device may comprise recommending one or more treatment devices adapted for one or more of lateral expansion, A-P movement, and/or vertical movement. Recommending the treatment device may comprise recommending one or more treatment devices from a plurality of possible recommended treatment devices for a particular type of movement. The particular type of movement is lateral expansion, and the plurality of possible recommended treatment devices comprises a palatal expander and a dental aligner. For example, outputting the treatment device recommendation may comprise recommending a palatal expander when at least one of the recommended treatment inter-arch width or the amount of recommended lateral expansion is above a threshold, optionally where the amount of recommended lateral expansion threshold is 4 mm or greater. In some cases outputting the treatment device recommendation may comprise recommending a dental aligner when at least one of the recommended treatment inter-arch width or the amount of recommended lateral expansion is at or below a threshold, optionally where the amount of recommended lateral expansion threshold is 4 mm. Outputting the treatment device recommendation may comprises providing the recommended treatment device from a plurality of possible treatment devices based on the recommended lateral expansion. Outputting the treatment device recommendation may comprise recommending a palatal expander when the recommended lateral expansion is above a threshold and recommending an aligner when the recommended lateral expansion is at or below a threshold. For example, calculating the recommended treatment may comprise calculating a recommended movement in an Anterior-Posterior (A-P) direction of the one or more of the patient's teeth. The recommended movement in the A-P direction may comprise mandibular advancement in an anterior direction or mandibular retraction in a posterior direction. Calculating the recommended movement in the A-P direction of the one or more of the patient's teeth may be further based on an age of the patient. In any of these methods and apparatuses, calculating the recommended movement in the A-P direction of the one or more teeth may be further based on whether or not the patient is undergoing a relatively increased rate of growth (growth spurt). Providing the recommended treatment may comprise providing a recommended treatment device based on the recommended A-P movement. The recommended treatment device may comprise one or more of buccal blocks or occlusal blocks. Calculating the recommended treatment movement of the one or more teeth may comprise calculating a recommended vertical movement of the one or more teeth.

In any of these methods and apparatuses, outputting the recommended treatment comprises outputting a predicted recommended treatment movement of the one or more teeth. For example, outputting the predicted recommended treatment movement may comprise recommending one or more of lateral expansion of the one or more teeth, movement in an A-P direction of the one or more teeth, or movement in a vertical direction of the one or more teeth.

For example, a method of determining, in real time, one or more interventions while scanning a patient's dentition may include: scanning the patient's dentition with an intraoral scanner; generating, while scanning the patient's dentition, a three-dimensional (“3D”) model of the patient's dentition; accumulating measurements, while scanning the patient's dentition, of one or more features of the 3D model of the patient's dentition; calculating, once the accumulated measurements exceed a confidence threshold, a recommended treatment of one or more of the patient's teeth based on at least some of the accumulated measurements and one or more of a features index based on patient-specific data and/or personalized doctor preferences; and outputting, while scanning the patient's dentition, the recommended treatment.

Also described herein are apparatuses (e.g., systems, devices, etc.) that may be configured to perform any of these methods, and may include hardware, software and/or firmware for performing any of these methods. These apparatuses may be intraoral scanners and/or may be incorporated with an intraoral scanner. The intraoral scanner may include a hand-held wand or other scanning element that may be operated by the user to scan the patient's dentition. Any of these apparatuses may include one or more processors and may include or access a memory storing instructions configured to operate the one or more processors. A processor may include hardware that runs the computer program code. Specifically, the term ‘processor’ may include a controller and may encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

For example, an intraoral scanning system may comprise: an intraoral scanner adapted for scanning an intraoral cavity; one or more processors; a memory storing computer-program instructions, that, when executed by the one or more processors, perform a computer-implemented method comprising: scanning the patient's dentition with an intraoral scanner; generating, while scanning the patient's dentition, a three-dimensional (“3D”) model of the patient's dentition; measuring, while scanning the patient's dentition, one or more features of the 3D model of the patient's dentition; calculating a recommended treatment of one or more of the patient's teeth based at least on the measured one or more features and a feature index based on patient-specific data; and outputting, while scanning the patient's dentition, the recommended treatment.

Any of these systems may include a display, wherein outputting the oral recommended treatment comprises visually displaying the recommended oral treatment on the display. The recommended treatment may be output to the display. Alternatively or additionally the apparatus may be configured so that the output comprises modifying the functioning of the operation of the intraoral scanner, including but not limited to displaying the recommended treatment on the intraoral scanner. For example, outputting may comprise visually presenting the recommended treatment on the display of the intraoral scanner. Visually presenting the recommended treatment may comprise visually presenting at least one of a recommended lateral expansion, a recommended Anterior-Posterior (A-P) movement, or a recommended vertical movement. In some cases visually presenting the recommended treatment may comprise visually presenting a one or more factors for the recommended treatment.

As mentioned, the apparatus may be configured to accumulate measurements of expected features while scanning the patient's dentition and wherein calculating comprises calculating once the accumulated measurements exceeds a confidence threshold. The confidence threshold may be determined based on the likelihood that the measurement parameters are complete (e.g., the distance between teeth edges, centers, etc. are fully scanned by the 3D model for a particular parameter to be measured, etc.). Any of these apparatuses may be configured to output a simulation of treatment that includes the recommended treatment.

As mentioned above, calculating the recommended treatment may be based on at least the measured one or more features and a feature index based on patient-specific data. In general, the feature index may be based on patient-specific data comprising one or more of: patient age, patient growth status, a predetermined treatment plan for the patient, and/or patient gender. For example, the feature index may be based on whether or not lower arch expansion is planned for the patient. In some cases calculating the recommended treatment comprises calculating a greater degree of recommended treatment movement when lower arch expansion is planned for the patient compared to when lower arch expansion is not planned for the patient. The recommended treatment movement may comprise upper lateral expansion, and the recommended treatment movement comprises a greater degree of recommended upper lateral expansion when lower arch expansion is planned compared to when lower arch expansion is not planned for the patient. In general, the apparatus may calculate the recommended treatment at least partially based on one or more doctor-specific factors comprising one or more doctor treatment preferences. The apparatus may access a database of users (e.g., doctors, including dentists, orthodontists, etc.) and associated preferences.

Any of these apparatuses may be configured to provide a justification or reasoning for the recommended treatment plan, and/or the supporting data. For example, providing a reasoning for the recommended treatment. The reasoning may be viewable upon user activation of a display screen interface (e.g., via an input such as but not limited to a touchscreen), allowing the user to view or not view the reasoning.

In any of these examples measuring one or more features of the 3D model may comprise measuring one or more of: upper first molar arch width, upper second premolar arch width, upper first premolar arch width, upper arch depth width ratio, lower first molar arch width, arch shape, or degree of upper crowding. Any of these apparatuses may include and/or access a trained machine learning agent when performing the calculation of the recommended treatment. For example the apparatus may calculate the recommended treatment by inputting the one or more features into a model trained to receive as input the one or more features and predict the recommended treatment movement. In some examples, the apparatus may calculate the recommended treatment by calculating at least one of a recommended lateral expansion of the one or more of the patient's teeth, a recommended movement in an Anterior-Posterior (A-P) direction of the one or more teeth, or a recommended movement in a vertical direction of the one or more of the patient's teeth. The apparatus may calculate the recommended treatment by calculating a recommended lateral expansion of the one or more of the patient's teeth. The apparatuses may output the recommend treatment by outputting at least one of a recommended inter-arch treatment width between first and second teeth, or an amount of recommended lateral expansion between the first and second teeth relative to a current inter-arch width based on the intraoral scan. The first and second teeth may comprise one or more of upper first molars, upper second premolars, or upper first premolars.

Any of these apparatuses may be configured to output (in some cases, as part of the recommend treatment) a treatment device recommendation based on the recommended treatment. The treatment device may an aligner or series of aligners, a retainer, a palatal expander, a tooth/bite ramp, etc.

Thus, described herein are apparatuses and methods for recommending an oral treatment for a patient when performing an intraoral scan of the patient's dentition, comprising: scanning a patient's dentition with an intraoral scanner; receiving or generating, by a processor in operable communication with the intraoral scanner, a three-dimensional (“3D”) model of the patient's dentition; measuring, by the processor, one or more features of the 3D model of the patient's dentition; calculating, by the processor, a recommended treatment movement of one or more of the patient's teeth based at least on the measured one or more features; and recommending an oral treatment based on the recommended treatment movement of the one or more teeth.

Also described herein are apparatuses and methods of recommending an oral treatment for a patient when performing an intraoral scan of the patient's dentition and based on one or more personalized doctor preferences, comprising: scanning a patient's dentition with an intraoral scanner; receiving or generating, by a processor in operable communication with the intraoral scanning device, a three-dimensional (“3D”) model of the patient's dentition; measuring, by the processor, one or more features of the 3D model of the patient's dentition; calculating, by the processor, a recommended treatment movement of one or more of the patient's teeth based at least on the measured one or more features and one or more personalized doctor preferences; and recommending an oral treatment based on the recommended treatment movement of the one or more teeth.

One aspect of the disclosure is an intraoral scanning system comprising: an intraoral scanner adapted for scanning an intraoral cavity; one or more processors; a memory coupled to the one or more processors, the memory storing computer-program instructions, that, when executed by the one or more processors, perform a computer-implemented method comprising: receiving or generating, by the one or more processors, a three-dimensional (“3D”) model of the patient's dentition based on an intraoral scan using the intraoral scanner; measuring, by the one or more processors, one or more features of the 3D model of the patient's dentition; calculating, by the one or more processors, a recommended treatment movement of one or more of the patient's teeth based at least on the measured one or more features; and recommending an oral treatment based on the recommended treatment movement of the one or more teeth.

In general, any of these methods may include providing one or more dental appliances (e.g., aligners, expanders, etc.) for treating the patient according to the recommended treatment(s). Thus, any of these methods and apparatuses may include fabricating one or more dental appliances for treating the patient according to the recommended treatment(s). Fabricating may include generating a model (e.g., a digital model), direct fabrication of the dental appliance(s), etc.

For example, described herein are methods: scanning a patient's dentition with an intraoral scanner; generating a three-dimensional (“3D”) model of the patient's dentition; measuring one or more patient-specific features specific to the 3D model of the patient's dentition; using a feature index to infer a relationship between the patient-specific features and one or more patterns in general treatment data; identifying one or more recommended treatments for the patient's dentition, the identifying based at least on an inferred relationship between the patient-specific features and the one or more patterns in the general treatment data; and outputting the one or more recommended treatments. These methods may be methods of recommending one or more treatments.

In any of these methods using the feature index to infer the relationship between the patient-specific features and the one or more patterns in the general treatment data may comprise predicting one or more discrete treatment classifications for the patient's dentition using the feature index. Using the feature index to infer the relationship between the patient-specific features and the one or more patterns in the general treatment data may comprise predicting one or more discrete treatment classifications for the patient's dentition using the feature index; and predicting the one or more discrete treatment classifications may comprise using a decision tree to classify the patient's dentition using the feature index.

The general treatment data may comprise real treatment data, synthetic treatment data, or some combination thereof. The general treatment data may comprise real treatment data corresponding to historical treatments, synthetic treatment data corresponding to modeled treatments, or some combination thereof. The general treatment data may be organized in a tabular format with a first data dimension representing individual instances of data and a second data dimension representing one or more treatment planning attributes to associate with the individual instances of data.

In any of these methods and apparatuses, the method may be executed while scanning the patient's dentition.

Outputting the recommended treatment may comprise displaying the recommended treatment on an intraoral scanner, a display of a treatment professional system, a display of a treatment planning system, or some combination thereof. Outputting the recommended treatment may comprise displaying a plurality of treatment recommendations for a given dental condition. In some cases outputting the recommended treatment comprises displaying a plurality of treatment recommendations for a given dental condition, and wherein the plurality of treatment recommendations comprise: a plurality of transverse expansion recommendations, a plurality of mesial-distal movement recommendations, a plurality of soft tissue treatment options, or some combination thereof. In any of these methods and apparatuses, outputting the one or more recommended treatments comprises displaying the one or more recommended treatments on a display of the intraoral scanner. Outputting the one or more recommended treatments may comprise displaying the one or more recommended treatments on a display of a doctor system. Outputting the one or more recommended treatments may comprise providing the one or more recommended treatments to an electronic prescription form. For example, outputting the one or more recommended treatments may comprise providing the more recommended treatments to an electronic prescription form as diagnostic insights in the electronic prescription form. In some cases outputting the one or more recommended treatments comprises populating one or more portions of an electronic prescription form with the one or more recommended treatments. Any of these methods may include configuring the electronic prescription form to receive an input from a treatment professional related to the one or more recommended treatments.

In any of these methods and apparatuses, outputting the one or more recommended treatments may comprise populating one or more portions of an electronic prescription form with the one or more recommended treatments. Any of these methods may include configuring the electronic prescription form to receive an input from a treatment professional related to the one or more recommended treatments, wherein the input comprises an approval, a modification, a denial, or some combination thereof. Outputting the one or more recommended treatments may comprise populating one or more portions of an electronic prescription form with the one or more recommended treatments. Any of these methods may include configuring the electronic prescription form to receive an input from a treatment professional related to treatments other than the one or more recommended treatments.

Outputting the one or more recommended treatments may comprise using the one or more recommended treatments to complete at least a portion of an electronic prescription form, receiving input comprising modifications, approvals, or some combination thereof to the electronic prescription form, and processing the input. In any of these examples, outputting the one or more recommended treatments comprises using the one or more recommended treatments to complete at least a portion of an electronic prescription form, receiving input comprising modifications, approvals, or some combination thereof to the electronic prescription form, and generating a treatment plan for the patient's dentition using the input.

Outputting the one or more recommended treatments may comprise translating the one or more recommended treatments to a domain-specific treatment protocol and using one or more translated recommended treatments translated to a domain-specific treatment protocol to complete at least a portion of an electronic prescription form. Outputting the one or more recommended treatments may comprise using the one or more recommended treatments to complete at least a portion of an electronic prescription form, and the portion may comprise: a transverse correction field displaying recommendations for arch expansion, palatal expansion, patient-specific transverse expansion parameters or some combination thereof; a mesial-distal correction field displaying options for mesial-distal correction, patient-specific mesial-distal correction parameters, or some combination thereof; an appliance field displaying recommendations for appliances to achieve the one or more recommended treatments; or some combination thereof.

Any of these methods may include identifying one or more dental appliances to implement the one or more recommended treatments. Any of these methods may include identifying one or more dental appliances to implement the one or more recommended treatments, wherein the one or more dental appliances comprises aligners, retainers, incremental palatal expanders, mandibular repositioning devices, or some combination thereof. Any of these methods may include identifying one or more dental appliances to implement the one or more recommended treatments, wherein the one or more dental appliances comprises: a series of aligners to reposition the patient's dentition from an initial arrangement toward a target arrangement. Any of these methods may include identifying one or more dental appliances to implement the one or more recommended treatments, wherein the one or more dental appliances comprises: a series of incremental palatal expanders to laterally expand the person's dentition. Any of these methods may include identifying one or more dental appliances to implement the one or more recommended treatments, wherein the one or more dental appliances comprises: one or more dental appliances with mandibular repositioning elements to move the patient's dentition along an anterior-posterior (A-P) direction.

Also described herein are systems for performing any of the methods described herein. For example, a system may include: one or more processors; a memory storing computer-program instructions, that, when executed by the one or more processors, perform a computer-implemented method comprising: scanning a patient's dentition with an intraoral scanner; generating a three-dimensional (“3D”) model of the patient's dentition; measuring one or more patient-specific features specific to the 3D model of the patient's dentition; using a feature index to infer a relationship between the patient-specific features and one or more patterns in general treatment data; identifying one or more recommended treatments for the patient's dentition, the identifying based at least on an inferred relationship between the patient-specific features and the one or more patterns in the general treatment data; and outputting the one or more recommended treatments.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIG. 1 is an exemplary method of recommending an oral treatment for a patient based on an intraoral can.

FIG. 2 is an exemplary method of calculating recommended treatment movement based on an intraoral can.

FIGS. 3-5 illustrate exemplary methods of calculating recommended treatment movements of one or more teeth based on the input one or more measured features.

FIG. 6 provides an exemplary method of training a trained prediction model.

FIGS. 7-9 illustrate exemplary treatment movements of one or more teeth.

FIG. 10 illustrates a plurality of exemplary measured one or more features of a 3D model of the patient's dentition.

FIG. 11 illustrates an exemplary simulated outcome of a recommended oral treatment.

FIG. 12 illustrates an example of recommending one or more oral treatments based on a recommended treatment movement of the one or more teeth.

FIGS. 13, 14, 15, 16, 17, 18a, 18b, 18c illustrate exemplary dental appliances that may be recommended by any of the methods and/or systems herein.

FIG. 19 represents a merely exemplary dental environment that may be used or incorporated with any of the systems and methods herein.

FIG. 20 illustrates an example of a method as described herein of identifying one or more recommended treatments.

FIG. 21 illustrates an example of a method as described herein, including automatically populating an electronic prescription form with one or more recommended treatments.

### DETAILED DESCRIPTION

Described herein are methods and apparatuses (e.g., systems, devices, etc., including software) for performing an intraoral scan. These methods and apparatuses may improve traditional intraoral scanning by analyzing and computing, in real time as the scan is occurring or immediately thereafter, one or more treatments. For example, these methods and apparatuses may be configured to detect one or more treatable orthodontic issues while scanning the patient and propose treatments (including orthodontic appliances). These methods and apparatuses may achieve this by calculating one or more metrics from the ongoing scan (and optionally in some cases once the scan has been completed) that indicate the need for particular treatments (e.g., interventions). Non-limiting examples of such treatments may include arch expansion, such as palatal expansion, which may be particularly helpful for orthopedic patients, e.g., by comparing one or more arch measurements to an arch expansion index that may be based on patient age and/or predicted growth stage. Other non-limiting examples may include detecting the need for mandibular advancement, upper arch distalization, and/or extraction for AP correction, e.g., by measuring, in real time as the scan in performed, an anterior-posterior (A-P) distance and comparing the estimated A-P distance to an A-P correction index.

The methods and apparatuses described herein may be particularly adapted to allow real-time detection of the need for one or more treatments. For example, these methods may accumulate scan data and may detect that sufficient scan data has been collected (and/or that the scan data collected is sufficient) to make one or more measurements necessary for determining if a treatment is necessary. Different treatments may require different measurements and these methods and apparatuses may be indicated in an ongoing manner as sufficient scan data is accumulated.

The methods and apparatuses described herein may assist in rapidly and accurately identifying and recommending orthodontic treatments to care providers based on an intraoral scan of a patient's dentition. These recommendations may be provided in real-time or near real-time during the intraoral scan, which may allow the user (e.g., dentist, orthodontist, dental technician) to modify the scan based on the proposed treatment, including scanning certain regions at different modalities (e.g., near-IR, florescent, etc.) and/or rescanning or scanning certain regions (e.g., the palatal region, gingiva, etc.). The disclosure may additionally be related to predicting a recommended treatment movement of one or more of the patient's teeth based on at least one or more features of a 3D model of the dentition based on the scan.

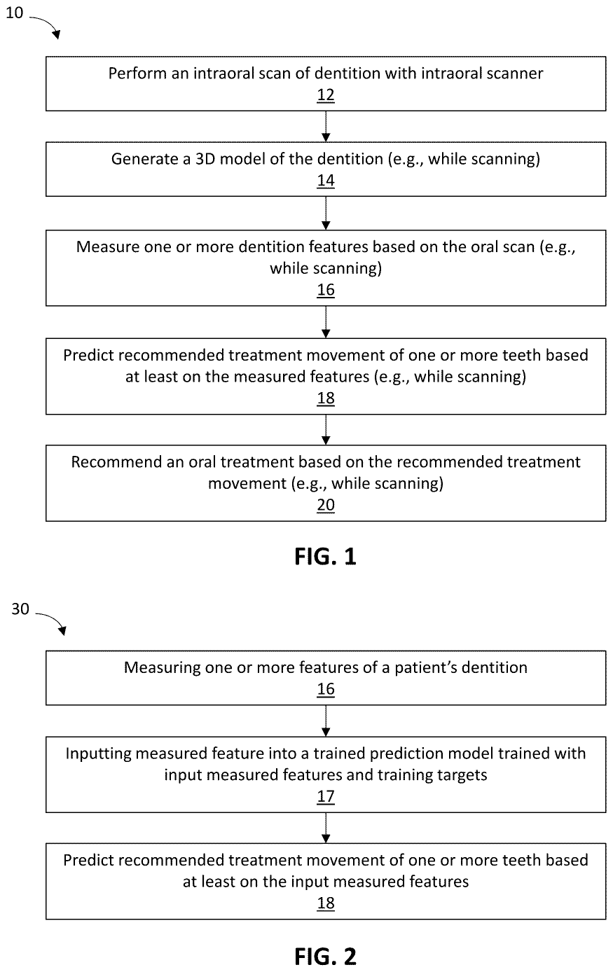

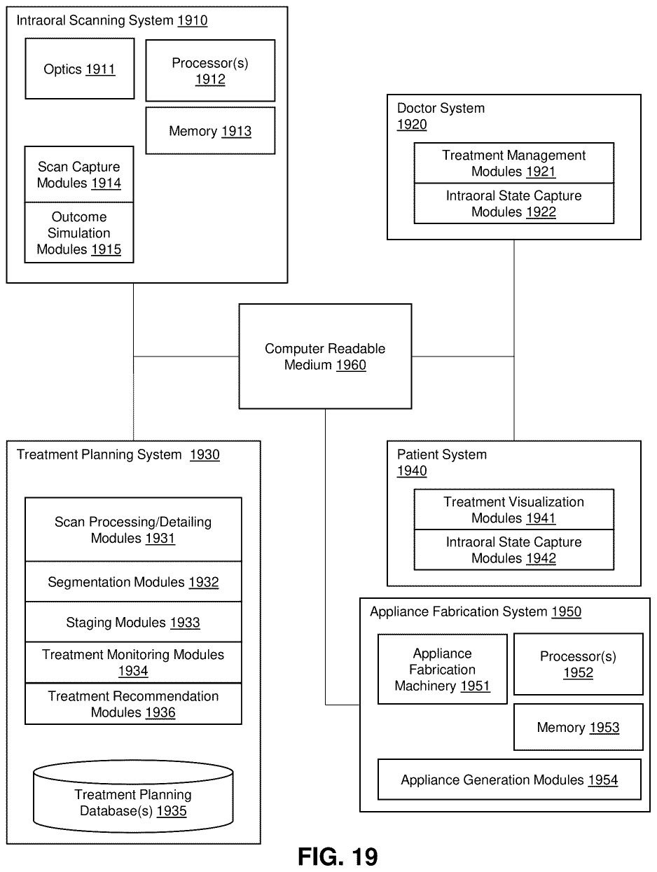

FIG. 1 illustrates an exemplary method 10 of recommending an oral treatment for a patient when performing an intraoral scan of the patient's dentition. Method 10 includes, at step 12, performing an intraoral scan of the patient's dentition with an intraoral scanner. Step 14 includes receiving or generating, optionally by a processor in operable communication with the intraoral scanner, a three-dimensional (“3D”) model of the patient's dentition. Step 16 includes measuring, optionally by the processor, one or more features of the 3D model of the patient's dentition. Step 18 includes calculating, optionally by the processor, a recommended treatment movement of one or more of the patient's teeth based at least on the measured one or more features. Step 20 includes recommending an oral treatment based on the recommended treatment movement of the one or more teeth. Method 10 may be performed by or with intraoral scanning system 1910 shown in FIG. 19, although method 10 may be performed with different systems within an environment, such as treatment planning system 1930 shown in FIG. 19. For example, processor 1912 that is part of intraoral scanning system 1910 may cause the performance of one or more of steps 14, 16, 18 and 20 in method 10.

FIG. 2 illustrates exemplary method 30 that includes calculating step 18 in FIG. 1. Method 30 includes step 16, which includes measuring one or more features of a patient's dentition. At step 17, the one or more measured features from step 16 are input into a trained prediction model that has been trained using input measured features and training targets. At step 18, the trained prediction model predicts recommended treatment movement of one or more teeth.

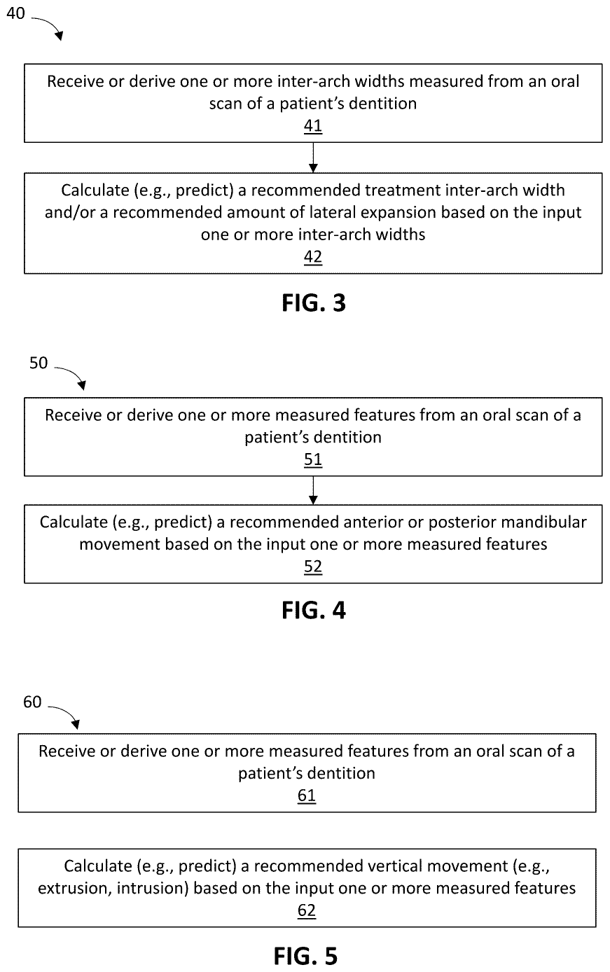

FIGS. 3, 4 and 5 illustrate methods that provide exemplary steps 17 and 18 from FIGS. 1 and 2. In method 40, the measured one or more features comprising inter-arch widths. At step 41, the one or more inter-arch widths are input into a trained prediction model. Step 42 comprises calculating a recommended treatment inter-arch width and/or a recommended amount of lateral expansion based on the input one or more measured inter-arch widths.

Method 50 in FIG. 4 includes step 51 that comprises inputting one or more measured features from an oral scan of a patient's dentition, and step 52 predicts a recommended anterior or posterior (“A-P”) mandibular movement based on the input one or more measured features.

Method 60 in FIG. 5 includes step 61 that comprises inputting one or more measured features from an oral scan of a patient's dentition, and step 62 predicts a recommended vertical movement (e.g., extrusion, intrusion) based on the input one or more measured features.

FIGS. 3, 4 and 5 are examples of prediction methods that may predict one or more of a recommended lateral expansion, a recommended A-P movement, or a recommended vertical movement.

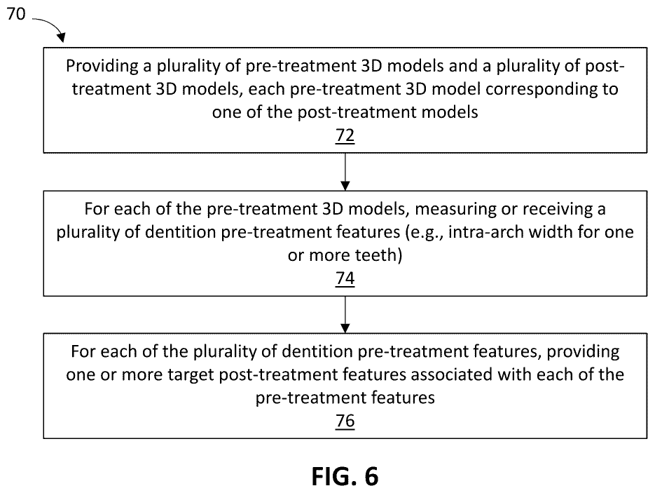

FIG. 6 illustrates an exemplary training process 70 of training any of the trained prediction models herein. An exemplary benefit of recommended treatment options herein is that the predictions and recommended treatments can be based on and trained with a large volume of patient data, which can better inform the care giver about the recommended treatments. Method 70 includes step 72, which includes providing a plurality of pre-treatment 3D models and a plurality of post-treatment 3D models (e.g., from a plurality of patients), each pre-treatment 3D model corresponding to one of the post-treatment models. At step 74, for each of the pre-treatment 3D models, the method can include measuring or receiving a plurality of dentition pre-treatment features (e.g., intra-arch width for one or more teeth). At step 76, the method can include, for each of the plurality of dentition pre-treatment features, providing one or more target post-treatment features associated with each of the pre-treatment features (e.g., a target arch width). Once trained with method 70, the trained model or method is adapted to predict one or more recommended treatment movements of one or more of the patient's teeth based at least on the input one or more features. The method can further recommend an oral treatment based on the predicted recommended treatment movement of the one or more teeth, which provides information to the caregiver based on the intraoral scan that they would otherwise not have access to, allowing them to make more informed decisions and/or consider treatment option they would otherwise not have considered.

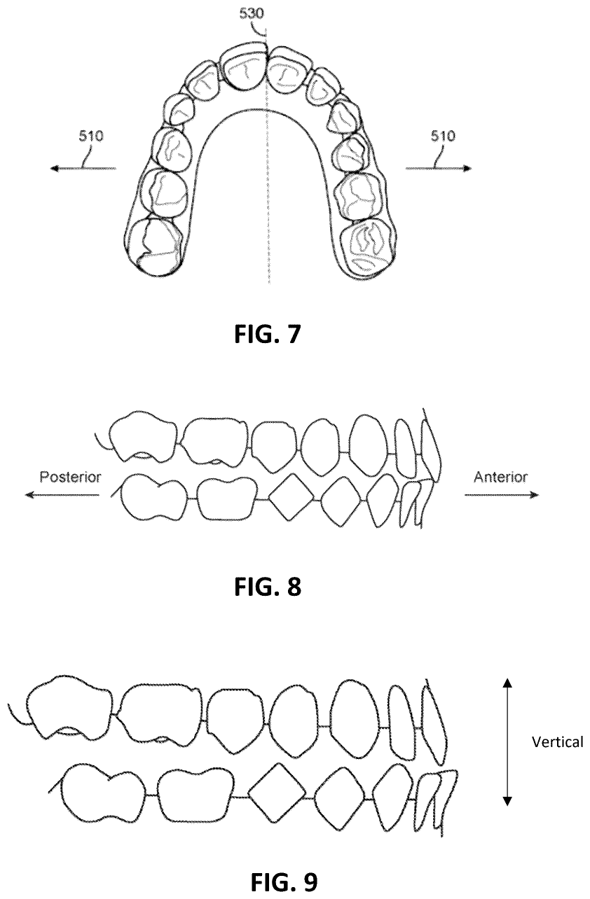

FIG. 7 illustrates lateral expansion direction as used herein. FIG. 8 illustrates anterior-posterior (AP) movement as used herein. FIG. 9 illustrates vertical direction as used herein, which may include extrusion/intrusion.

Methods of oral treatment recommendations herein that include scanning a patient's dentition with an intraoral scanner (such as at step 12 in FIG. 1) may include using a variety of intraoral scanners, which may be part of intraoral scanning system 1910 shown in FIG. 19. The iTero™ intraoral scanner by Align is a mere example of an intraoral scanner adapted to scan a patient's dentition. As set forth herein, scanning the dentition is optionally performed by a pediatric dentist or an individual on a care team of the pediatric dentist, a GP or an individual on a care team of the GP, or an orthodontist or an individual on a care team of the orthodontist. Recommending the oral treatment may comprise recommending an oral treatment to the pediatric dentist, GP, or orthodontist (or other care provider), respectively.

Methods of oral treatment recommendations herein may optionally include receiving or generating, by a processor in operable communication with the intraoral scanner, a three-dimensional (“3D”) model of the patient's dentition, such as at step 14 in method 10 in FIG. 1. This step may optionally be performed by or with intraoral scanning system 1910 in FIG. 19, such as with processor 1912. This step may optionally be performed by or with treatment planning system 1930.

Methods of oral treatment recommendations herein may optionally include measuring, by a processor, one or more features of the 3D model of the patient's dentition. The one or more features of the 3D model may comprise one or more of upper first molar arch width, upper second premolar arch width, upper first premolar arch width, upper arch depth width ratio, lower first molar arch width, arch shape, or degree of upper crowding, as well as other dentition features.

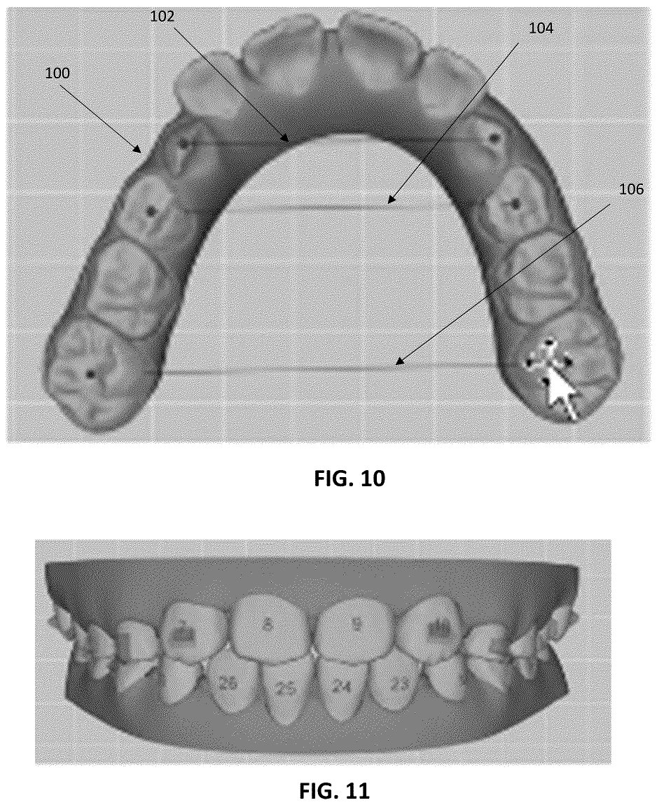

FIG. 10 illustrate an exemplary 3D model 100 of a patient's upper dentition and exemplary measured features, such as upper canine width 102, upper first premolar arch width 104 and upper first molar arch width, which are mere examples of input features into any of the trained prediction models herein.

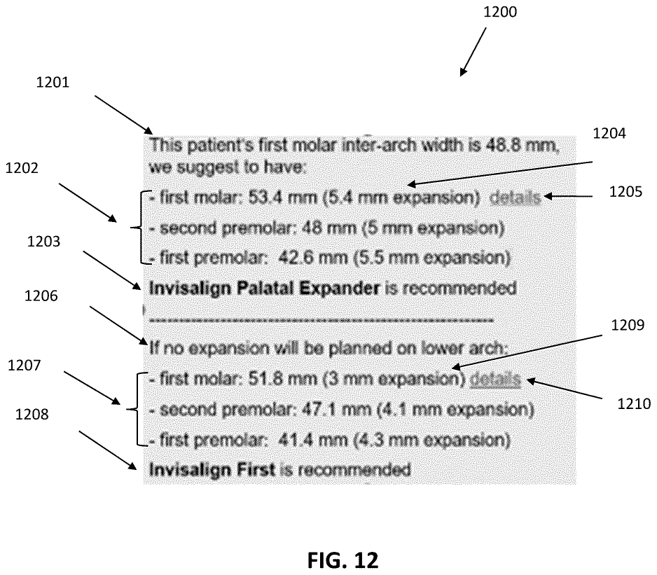

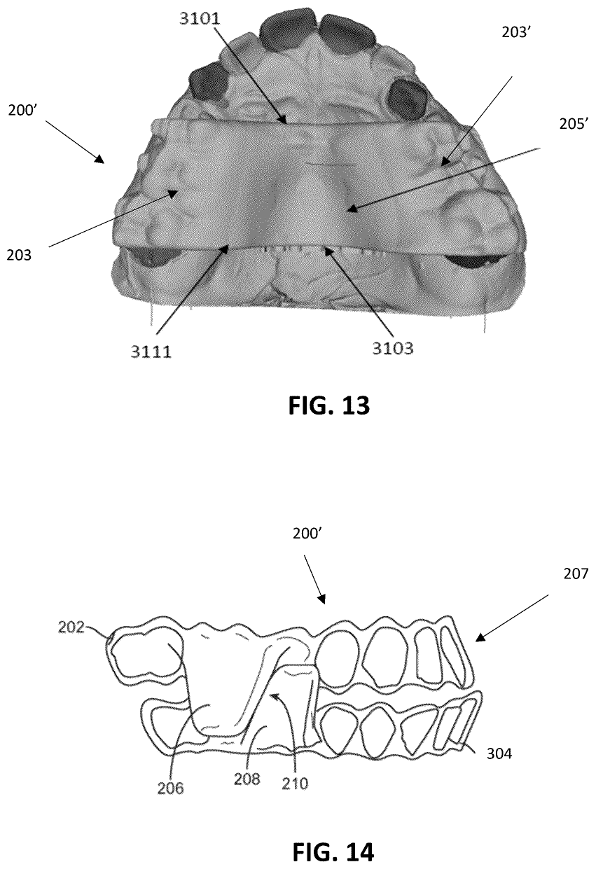

Methods of oral treatment recommendations herein may include calculating, by a processor, a recommended treatment movement of one or more of the patient's teeth based at least on the measured one or more features, examples of which are shown in FIG. 12. FIG. 12 illustrates an exemplary output 1200, which in this example is a visual output that may be visually presented on a screen or display, such as a display or screen of intraoral scanning system 1910 or treatment planning system 1930 as in FIG. 19. Output 1200 in this example includes one or more measured features 1201, which in this example is a visual display of the patient's first molar inter-arch width, which in this example is 48.8 mm. Visual output 1200 further comprises recommended treatment movement of one or more teeth 1202, 1204, 1207 and 1209. Output 1200 further comprises recommended oral treatments 1203 and 1208, which in this example include examples of recommended oral devices, although other recommended oral devices may be recommended, depending on the type and/or direction of movement. In this example, the output 1200 also includes recommendations if no expansion is planned for a lower arch 1206. Output 1200 also optionally includes user interfaces 1205 and 1210 (clickable “detail” text) that allows a user to click on the text to create an additional display of additional information, such as more detail reasoning, explanation, and/or primary factors for the recommendations. The one or more recommended treatment movements herein (e.g., 1202, 1204, 1207, 1209) may also be considered part of the recommended oral treatment.

In the example of FIG. 12, the predicted treatment movement of the one or more teeth and the recommended oral treatment are related to lateral expansion of an upper jaw. However, methods of recommending oral treatment herein can similarly be used to predict treatment movement of the one or more teeth and recommend oral treatment in other types of movement and optionally may include a plurality of different types of movement and recommendation at the same time. Predicting the recommended treatment movements of the one or more teeth herein comprises calculating at least one of a recommended lateral expansion of the one or more teeth (an example of which is shown in FIG. 12), a recommended movement in an A-P direction of the one or more teeth (the directions of which are shown in FIG. 8), or a recommended movement in a vertical direction of the one or more teeth (the direction of which are shown in FIG. 8).

In this example shown in FIG. 12, recommended movement of one or more teeth 1202 and 1207 are specific recommended distances for a particular feature (total arch width), whereas recommended movements 1204 and 1209 provide recommended movement dimensions relative to the existing feature (amount of expansion relative to current distance in this example). Either type of recommended movement (total, or movement relative to an existing dimension) may be used in any of the methods of recommendation herein.

In the example shown in FIG. 12, the recommended treatment movement includes movement for upper first molars, upper second premolars, and upper first premolars, but the recommended treatment movement may be other teeth as well, particularly if other types of movement other than lateral expansion are being recommended (e.g., AP, vertical and/or lateral movement, in any combination thereof).

The output 1200 in FIG. 12 is an example of recommending an oral treatment that comprises providing one or more recommended treatment device 1203 and 1208 based on the recommended treatment movement, in this example, recommended lateral expansion.

Providing a recommended treatment device herein may comprise recommending a palatal expander when at least one of the recommended treatment inter-arch width (e.g., 1202) or the amount of recommended lateral expansion (e.g., 1204) is above a threshold, optionally where the amount of recommended lateral expansion threshold is 4 mm. In the example shown in FIG. 12, the three inter-arch expansions are greater than 4 mm.

Providing a recommended treatment device herein may comprise recommending a dental aligner when at least one of the recommended treatment inter-arch width or the amount of recommended lateral expansion is at or below a threshold, optionally where the amount of recommended lateral expansion threshold is 4 mm.

Providing a recommended treatment device herein may comprise recommending a dental aligner when at least one of the recommended treatment inter-arch width or the amount of recommended lateral expansion is at or below a threshold and optionally may be recommended if no lower arch expansion is planned, as shown in the example of FIG. 12.

In the example in FIG. 12, an aligner such as Invisalign First is recommended, and recommended lateral expansion 1209 includes 3 mm, 4.1 mm, and 4.3, respectively, as shown.

FIG. 12 is an example wherein providing the recommended treatment device comprises providing the recommended treatment device from a plurality of possible treatment devices based on the recommended lateral expansion, although as set forth above, other possible treatment devices may be among the plurality, particularly if other types of teeth movement are recommended (e.g., AP and/or vertical).

Methods of oral treatment recommendations herein are optionally adapted to predict recommended movement in an A-P direction of the one or more teeth, such as for an underbite, overbite, cross-bite, Class II malocclusions, Class III malocclusions, wherein the care provider can be provided with recommended treatment options they may not be considering and/or to better inform their treatment plan. For example, recommended movement in the A-P direction may comprise a recommended distance for movement of one or more teeth in an anterior direction or recommended distance for movement of one or more teeth in a posterior direction.

For some patients, the age of the patient may be a factor considered as part of the automated treatment recommendations herein. For example, for some type of movement such as AP movement, the age of the patient may be relevant to consider whether or not the patient is in period of their life with a relatively increased rate of growth (e.g., a growth spurt).

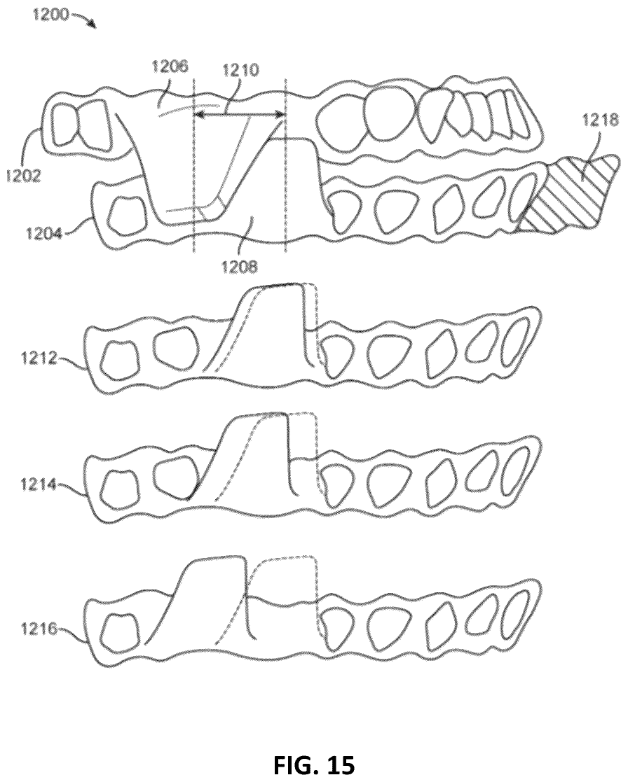

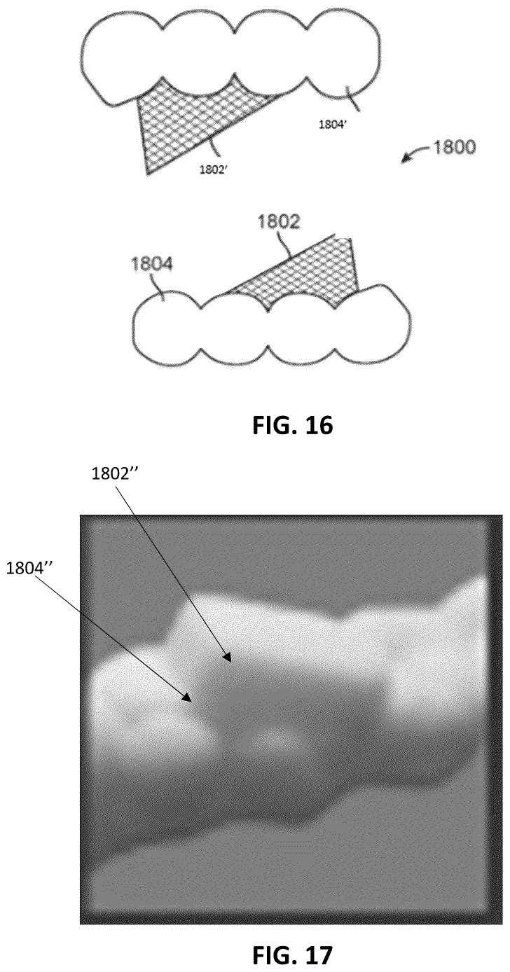

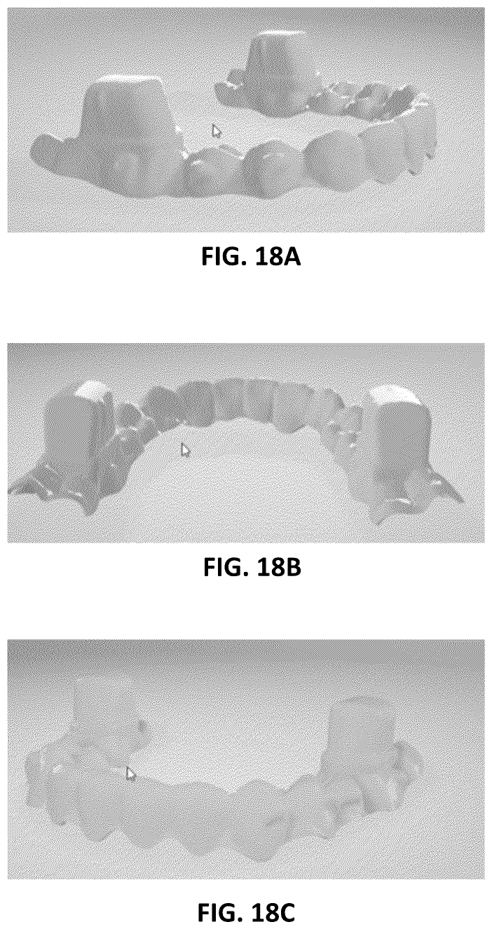

Methods of oral treatment recommendations herein that are adapted to provide a recommended AP movement optionally comprises providing a recommended treatment device based on the recommended A-P movement. For example, recommended treatment devices based on recommended AP movement include one or more devices (e.g., aligners) with one or more occlusion blocks, buccal blocks (wings), or other movement features incorporated into the oral appliance adapted to cause AP movement of one or more of the patient's teeth, example of which are shown in FIGS. 14, 15, 16, 17, and 18A-18C.

Methods of oral treatment recommendations herein are optionally additionally adapted to predict recommended movement for one or more teeth in a vertical direction (e.g., intrusion, extrusion), and optionally recommending an oral treatment for one or more teeth in the vertical direction based on the predicted movement.

As shown in the example of FIG. 12, calculating the recommended treatment movement is optionally based on whether or not lower arch expansion is planned for the patient. For example, if lower arch expansion is not planned for the patient, less expansion may be needed for the upper jaw, and again, for example only, an aligner rather than a palatal expander may be recommended for the upper jaw in this situation. Similarly, if lower arch expansion is planned for the patient, the systems and methods herein are optionally adapted to consider this as a feature into calculating the one or more teeth movements. Similarly, any of the trained models herein may be trained on features that include the feature of whether or not lower arch expansion was planned for the patient.

Methods and systems of oral treatment recommendations herein may include a user interface feature (such as a touchable or clickable icon on a display screen that is part of a system) adapted to be selected by the care giver to indicate whether or not lower arch expansion is planned for that patient, and which optionally is input into the system and method to consider that as part of the recommended teeth movement and/or recommended oral treatment.

Methods of oral treatment recommendations herein may include recommending an oral treatment based on recommended treatment movement of the one or more teeth, an example of which is step 20 in FIG. 1. Recommending the oral treatment may comprising visually presenting the recommended oral treatment on a display in communication with the intraoral scanning device, an example of which is shown in FIG. 12. Visually presenting a recommended oral treatment may comprise visually presenting at least one of a recommended lateral expansion, a recommended A-P movement, or a recommended vertical movement, an example of which is shown in FIG. 12.

Methods of oral treatment recommendations herein may also include providing (optionally visually presenting) a reasoning or one or more primary factors for the recommended oral treatment. This may allow the care team (e.g., dentist, GP, orthodontist) within a rationale for why the automated treatment recommendation is provided. This may further help inform the care team with information they otherwise would not have access to, may help them consider treatment options if there are a plurality of viable options (e.g., “on the fence” decision making), and/or be a trained second pair of digital eyes that may provide better patient outcomes.

Any of the methods of oral treatment recommendations herein may be further adapted to visually providing a simulation of treatment that includes the recommended treatment movement of the one or more teeth and the one or more recommended oral treatments, an example of which is shown in FIG. 11. For example, intraoral scanning system 1910 or treatment planning system 1930 may include a screen or display that is adapted to visually provide a simulation of treatment that includes the recommended treatment movement of the one or more teeth and the one or more recommended oral treatments. The visualized simulation can further help inform the care team (optionally including the patient or parents of the patient) with information they otherwise would not have access to, may help them consider treatment options if there are a plurality of viable options (e.g., “on the fence” decision making), and/or be a trained second pair of digital eyes that may provide better patient outcomes. This is another example of how the systems and methods herein are an improvement to technology not otherwise available to oral care givers, and which can improve their general level or expertise and/or improve patient outcomes.

The systems and methods herein that include a treatment outcome simulator may include providing a visual representation of the simulated outcome and may include the simulated one or recommended treatment movement in one or more types of movement (e.g., lateral, AP and/or vertical). The system may be adapted to provide the simulated treatment outcome based on a user request, such as an icon on a display that when touched or clicked (or responsive to other user inputs such as voice response), present the visual simulated treatment outcome based on the recommended oral treatment.

As described herein, predicted anterior-posterior (“AP”) movement and/or recommended oral treatment that includes AP movement of one or more teeth may include predicted movement and/or recommended oral treatment for teeth in one or both of a subject's mandible or maxilla. Recommended oral treatment herein that may comprise AP treatment may include one or more of moving the mandible in the anterior direction, moving the mandible in the posterior direction, moving the maxilla in the anterior direction, and moving the maxilla in the posterior direction. In some recommended treatments, AP treatment may apply a net anterior (protrusive) force on the patient's mandible. In some recommended treatments, AP treatment may apply a net posterior (retrusive) force on the patient's maxilla. In some recommended treatments, AP treatment may apply a net posterior (retrusive) force on the patient's mandible. In some recommended treatments, AP treatment may apply a net anterior (protrusive) force on the patient's maxilla.

An exemplary but non limiting advantage of recommended oral treatments herein is the ability to one or more recommended oral treatments based on predicted recommended treatment movements of one or more teeth based on an intraoral scans, which may not have been previously achievable.

In general, the methods and apparatuses herein (systems, devices, etc., including software, hardware and/or firmware) may be used at one or more parts of a dental computing environment, such as exemplary environment 1900, including as part of an intraoral scanning system 1910, doctor system 1920, treatment planning (e.g., technician) system 1930, patient system 1940, and/or fabrication system 1950. In particular, these methods and apparatuses may be used as part of system 1900, for example, to recommend an oral treatment based on recommended treatment movement of one or more teeth.

FIG. 19 is a diagram illustrating one variation of a computing environment 1900 that may generate one or more predicted and/or recommended orthodontic treatment plans specific to a patient and fabricate dental appliances that may accomplish the treatment plan to treat a patient, under the direction of a dental professional. The example computing environment 1900 shown in FIG. 19 includes an intraoral scanning system 1910, a doctor system 1920, a treatment planning system 1930 (e.g., technician system), a patient system 1940, an appliance fabrication system 1950, and computer-readable medium 1960. Each of these systems may be referred to equivalently as a sub-system of the overall system (e.g., computing environment). Although shown as discrete systems, some or all of these systems may be integrated and/or combined. In some variations a computing environment (dental computing system) 1900 may include just one or a subset of these systems (which may also be referred to as sub-systems of the overall system 1900). As mentioned, one or more of these systems may be combined or integrated with one or more of the other systems (sub-systems), such as, e.g., the patient system and the doctor system may be part of a remote server accessible by doctor and/or patient interfaces. The computer readable medium 1960 may be divided between all or some of the systems (subsystems); for example, the treatment planning system and appliance fabrication system may be part of the same sub-system and may be on a computer readable medium 1960. Further, each of these systems may be further divided into sub-systems or components that may be physically distributed (e.g., between local and remote processors, etc.) or may be integrated.

An intraoral scanning system may include an intraoral scanner as well as one or more processors for processing images. For example, an intraoral scanning system 1910 can include optics 1911 (e.g., one or more lenses, filters, mirrors, etc.), processor(s) 1912, a memory 1913, scan capture module 1914, and outcome simulation module 1915. In general, the intraoral scanning system 1910 can capture one or more images of a patient's dentition. Use of the intraoral scanning system 1910 may be in a clinical setting (doctor's office or the like) or in a patient-selected setting (the patient's home, for example). In some cases, operations of the intraoral scanning system 1910 may be performed by an intraoral scanner, dental camera, cell phone or any other feasible device.

The optical components 1911 may include one or more lenses and optical sensors to capture reflected light, particularly from a patient's dentition. The scan capture module 1914 can include instructions (such as non-transitory computer-readable instructions) that may be stored in the memory 1913 and executed by the processor(s) 1912 to can control the capture of any number of images of the patient's dentition.

For example, the outcome simulation module 1915, which may be part of the intraoral scanning system 1910, can include instructions that simulate the tooth positions based on a treatment plan. Alternatively or additionally, in some examples, the outcome simulation module 1915 can import tooth number information from 3D models onto 2D images to assist in determining an outcome simulation.

Any of the component systems or sub-systems of the dental computing environment 1900 may access or use the 3D model of the patient's dentition generated by the methods and apparatuses described herein. For example, the doctor system 1920 may include a treatment management module 1921 and an intraoral state capture module 1922 that may access or use the 3D model. The doctor system 1920 may provide a “doctor facing” interface to the computing environment 1900. The treatment management module 1921 can perform any operations that enable a doctor or other clinician to manage the treatment of any patient. In some examples, the treatment management module 1921 may provide a visualization and/or simulation of the patient's dentition with respect to a treatment plan.

The intraoral state capture module 1922 can provide images of the patient's dentition to a clinician through the doctor system 1920. The images may be captured through the intraoral scanning system 1910 and may also include images of a simulation of tooth movement based on a treatment plan.

In some examples, the treatment management module 1921 can enable the doctor to modify or revise a treatment plan, particularly when images provided by the intraoral state capture module 1922 indicate that the movement of the patient's teeth may not be according to the treatment plan. The doctor system 1920 may include one or more processors configured to execute any feasible non-transitory computer-readable instructions to perform any feasible operations described herein.

Alternatively or additionally, the treatment planning system 1930 may include any of the methods and apparatuses described herein. The treatment planning system 1930 may include scan processing/detailing module 1931, segmentation module 1932, staging module 1933, treatment monitoring module 1934, treatment recommendation modules 1936, and treatment planning database(s) 1935. In general, the treatment planning system 1930 can determine a treatment plan for any feasible patient. The scan processing/detailing module 1931 can receive or obtain dental scans (such as scans from the intraoral scanning system 1910) and can process the scans to “clean” them by removing scan errors and, in some cases, enhancing details of the scanned image. The treatment planning system 1930 may perform segmentation. For example, a treatment planning system may include a segmentation module 1932 that can segment a dental model into separate parts including separate teeth, gums, jaw bones, and the like. In some cases, the dental models may be based on scan data from the scan processing/detailing module 1931.

The staging module 1933 may determine different stages of a treatment plan. Each stage may correspond to a different dental appliance (aligner, palatal expander, etc.) shaped to implement force systems and/or displacements to modify dentition toward that stage. The staging module 1933 may also determine the final position of the patient's teeth, in accordance with a treatment plan. Thus, the staging module 1933 can determine some or all of a patient's orthodontic, restorative, and/or dental treatment plan. In some examples, the staging module 1933 can simulate movement of a patient's teeth in accordance with the different stages of the patient's treatment plan.

The treatment monitoring module 1934 can implement instructions to monitor progress of an orthodontic treatment plan. In some examples, the treatment monitoring module 1934 can provide an analysis of progress of treatment plans to a clinician.

The treatment recommendation module(s) 1936 can implement instructions to evaluate patient-specific features against patterns in general treatment data. The treatment recommendation module(s) 1936 can use a feature index as a measure to infer relationships between patient-specific features and patterns in general treatment data. As an example of operation, the treatment recommendation module(s) 1936 can obtain from the treatment planning database(s) 1935 patient-specific features related to a person's dentition and a model representing patterns in general treatment data. The treatment recommendation module(s) 1936 can use a feature index to associate patient-specific features with patterns in general treatment data. The treatment recommendation module(s) 1936 can use decision determinations (e.g., decision trees) and/or other relevant methodologies to infer relationship between the patient-specific features and one or more patterns in general treatment data.

The treatment recommendation module(s) 1936 can output recommended treatments to other modules and/or systems. As examples, the treatment recommendation module(s) 1936 can provide treatment recommendations to the intraoral scanning system 1910, the doctor system 1920, and/or other modules of the treatment planning system 1930. As a specific example, the treatment recommendation module(s) 1936 can show movement patterns, staging patterns, treatment options, and/or ways to modify oral anatomy on clinical software the intraoral scanning system 1910, the doctor system 1920, and/or other modules of the treatment planning system 1930. Movement patterns, staging patterns, treatment options, and/or ways to modify oral anatomy can be rendered on, e.g., a 3D model representing a person's dentition, images of a person's dentition, etc. Movement patterns, staging patterns, treatment options, and/or ways to modify oral anatomy can be displayed as options for treatment. As an example, for a patient for whom transverse expansion is desirable, options to perform palatal expansion (e, g., with a Hyrax device, incremental palatal expanders, etc.), arch expansion (e.g., with aligners or other appliances), etc. may be displayed as discrete treatment options. As another example, for a patient for whom mesial-distal correction is desirable, options for various mesial-distal treatment parameters and/or appliances can be displayed. In some implementations, treatment recommendation module(s) 1936 formats treatment recommendations in an electronic prescription form displayed on the intraoral scanning system 1910, the doctor system 1920, the treatment planning system 1930, the patient system 1940, or some combination thereof. The treatment recommendation module(s) 1936 can format treatment recommendations and/or treatment parameters into fields of an electronic prescription form. An electronic prescription form displayed on a display of the intraoral scanning system 1910, the doctor system 1920, the treatment planning system 1930, the patient system 1940, or some combination thereof, can include fields and/or other areas that, e.g., are pre-populated using treatment recommendations.

Treatment planning database(s) 1935 can store data related to treatment plans and/or to treatment recommendations. As an example, treatment planning database(s) 1935 can store 3D models used for treatment planning and other patient-specific data, such as information related to an individual patient's health, diagnosis, and/or treatment. As noted herein, patient-specific data may include attributes of a specific patient's dentition and/or demographic and/or other patient historical factors for a specific patient. Treatment planning database(s) 1935 may also store general treatment data including real treatment data, synthetic treatment data, and/or information from past and/or hypothetical treatments (e.g., historical treatment information, modeled treatment information, etc.). Treatment planning database(s) 1935 can store treatment data as structured data representing dentition attributes, historical factors, and/or other information related to historical and/or modeled treatments.

In various implementations, treatment planning database(s) 1935 store machine learning models that are trained to recognize patterns in general treatment data and make predictions on new and/or unanalyzed data. Models may be trained to recognize patterns in general treatment data that are applicable to anatomical features, treatment outcomes, etc. A machine learning model stored in treatment planning database(s) 1935 may comprise a serialized architecture and/or having learned parameters stored in a file in the treatment planning database(s) 1935.

Although not shown here, the treatment planning system 1930 can include one or more processors configured to execute any feasible non-transitory computer-readable instructions to perform any feasible operations described herein.

The patient system 1940 can include a treatment visualization module 1941 and an intraoral state capture module 1942. In general, the patient system 1940 can provide a “patient facing” interface to the computing environment 1900. The treatment visualization module 1941 can enable the patient to visualize how an orthodontic treatment plan has progressed and also visualize a predicted outcome (e.g., a final position of teeth).

In some examples, the patient system 1940 can capture dentition scans for the treatment visualization module 1941 through the intraoral state capture module 1942. The intraoral state capture module can enable a patient to capture his or her own dentition through the intraoral scanning system 1910. Although not shown here, the patient system 1940 can include one or more processors configured to execute any feasible non-transitory computer-readable instructions to perform any feasible operations described herein.

The appliance fabrication system 1950 can include appliance fabrication machinery 1951, processor(s) 1952, memory 1953, and appliance generation module 1954. In general, the appliance fabrication system 1950 can directly or indirectly fabricate aligners to implement an orthodontic treatment plan. In some examples, the orthodontic treatment plan may be stored in the treatment planning database(s) 1935.

The appliance fabrication machinery 1951 may include any feasible implement or apparatus that can fabricate any suitable dental aligner. The appliance generation module 1954 may include any non-transitory computer-readable instructions that, when executed by the processor(s) 1952, can direct the appliance fabrication machinery 1951 to produce one or more dental aligners. The memory 1953 may store data or instructions for use by the processor(s) 1952. In some examples, the memory 1953 may temporarily store a treatment plan, dental models, or intraoral scans.

The computer-readable medium 1960 may include some or all of the elements described herein with respect to the computing environment 1900. The computer-readable medium 1960 may include non-transitory computer-readable instructions that, when executed by a processor, can provide the functionality of any device, machine, or module described herein.

As mentioned above, in general, the methods and apparatuses described herein may use one or more trained machine learning agents and/or artificial intelligence (AI) agents. In some cases an ML agent may assist with the tabular classification for orthodontic treatment recommendations. In general, orthodontic treatment planning is a complex process that requires careful analysis of a patient's dental and skeletal structures. Traditionally, orthodontists rely on their clinical experience and diagnostic tools such as intraoral scans, radiographs, and photographs to determine the most appropriate treatment plan. The methods and apparatuses described herein may use a tabular classification models such as LightGBM (Light Gradient Boosting Machine), Extreme Gradient Boosting (XGBoost), CatBoost, etc. As one example, LightGBM is a high-performance ML algorithm designed for speed and efficiency when working with structured data. The methods and apparatuses described herein may train a tabular classification model, such as LightGBM, on a dataset of intraoral scan-derived parameters and corresponding treatment decisions, as part of a system that can recommend orthodontic and dental treatments for new patients in real time, potentially even during the scanning process at the chairside. In some cases a robust dataset, composed of historical patient records, may be used. Each record may include detailed features extracted from intraoral scans, along with the treatments that were ultimately administered. These features may include: tooth-level metrics (angulation, rotation, and position), arch characteristics (e.g., arch form, symmetry, and arch length discrepancy, etc.), occlusal relationships (e.g., overbite, overjet, crossbite, midline deviation, etc.), spacing and crowding measurements, skeletal parameters (e.g., jaw alignment and facial proportions, etc.), demographic data (e.g., age, gender, medical history, etc.).

Before training the model, the data may be preprocessed to ensure quality and consistency. This may include cleaning the data to handle missing values, normalizing continuous variables, and encoding categorical variables. Feature engineering may also be applied to derive new insights from existing data, such as calculating ratios or combining multiple measurements to better represent clinical concepts.

For example, if a tabular classification model such as LightGBM is used, a gradient boosting framework may be applied that builds decision trees iteratively, optimizing for accuracy while maintaining computational speed. This may be particularly beneficial in clinical settings where real-time or near-real-time inference is required. For example, the model may be trained using supervised learning. Each training example consists of a set of input features derived from intraoral scans and a corresponding label representing the treatment decision made by the orthodontist. These labels can be multi-class (e.g., braces, clear aligners, palatal expansion, extractions, surgical interventions, or any other treatment) or multi-label (e.g., a combination of treatments).

To ensure the model generalizes well to new patients, cross-validation techniques may be employed during training. Hyperparameters such as the number of leaves, learning rate, maximum tree depth, and boosting iterations may be tuned to optimize performance. The model's effectiveness may be evaluated using metrics such as accuracy, precision, recall, F1-score, and the area under the receiver operating characteristic curve (AUC-ROC).

Once trained, the tabular classification model may be deployed within the orthodontic clinic's digital infrastructure. The system may be configured to integrate seamlessly with intraoral scanning devices and electronic health record (EHR) systems. When a new patient undergoes an intraoral scan, the system may automatically extract relevant features from the scan data and feeds them into the trained model.

In some examples the model may then perform inference, e.g., generating a ranked list of recommended treatments based on the patient's specific anatomical and clinical characteristics. These recommendations may be presented to the user (e.g., orthodontist) in a user-friendly interface, allowing for immediate review and discussion with the patient. This chairside application may enable clinicians to make informed decisions quickly, improving workflow efficiency and enhancing patient engagement. Alternatively or additionally, the method and apparatus may provide output just to the use, and/or may populate or help populate a prescription/treatment form, such as (but not limited to) and electronic treatment form.

These methods and apparatuses may also be configured to enhance to ability of the user to interpret and understand the recommendations, as mentioned above. Any of these methods and apparatuses may include one or more techniques for explaining the output of the ML model, such as SHAP (SHapley Additive explanations), to provide insights into feature importance and decision pathways.

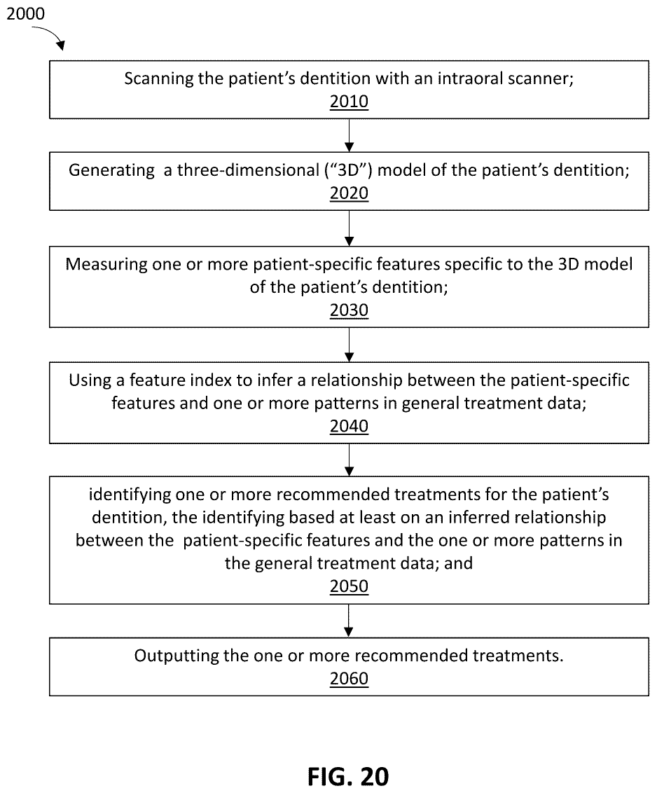

FIG. 20 illustrates one example of a method 2000 as described herein. In FIG. 20 this method illustrated is one example of a method of outputting one or more treatment recommendations. For example, any of these methods may include receiving or scanning the patient's dentition with an intraoral scanner 2010. This may include capturing a detailed digital representation of the patient's teeth and oral structures using an intraoral scanner, and/or receiving the digital representation from a patient that was previously scanned. Although most of the examples described herein are in the context of chairside (e.g., real or near-real time) treatment recommendations, any of these methods may also be used after scanning, including many days or months after scanning.

A three-dimensional (“3D”) model of the patient's dentition may then be generated from the scan data 2020. Alternatively in some cases the 3D model may be received in lieu of the scan data. The 3D model may be complete or partial (e.g., generated while scanning). Thus the receiving/scanning step 2010 and the model generation 2020 may be performed together in some cases. This model provides an accurate spatial representation, enabling clinicians to visualize the dentition from multiple angles.

The method may generally include estimating or measuring one or more patient-specific features specific to the 3D model of the patient's dentition 2030. For example, the system may extract quantitative and qualitative features from the 3D model. These features may include tooth alignment, spacing, occlusion patterns, arch form, and other structural characteristics unique to the patient. The features estimated/measured may be any of the features described above. This step may be performed by an ML agent, as described above. The method may further including using a feature index to infer a relationship between the patient-specific features and one or more patterns in general treatment data 2040. The measured features may be compared against a feature index. This step may be performed by an ML agent, as described above (the same or a different agent, if one is used, for feature extraction).

Any of these methods may include identifying one or more recommended treatments for the patient's dentition 2050, for example, identifying based at least on an inferred relationship between the patient-specific features and the one or more patterns in the general treatment data. Based on the inferred relationships, the method or apparatus (e.g., system) may determine one or more treatment options tailored to the patient's needs.

The method of apparatus may then output the one or more recommended treatments 2060 and/or one or manufacture (cause to be manufactured) one or more dental appliances, etc. Alternatively or additionally, the output may include completing a prescription from (e.g., an electronic prescription form.

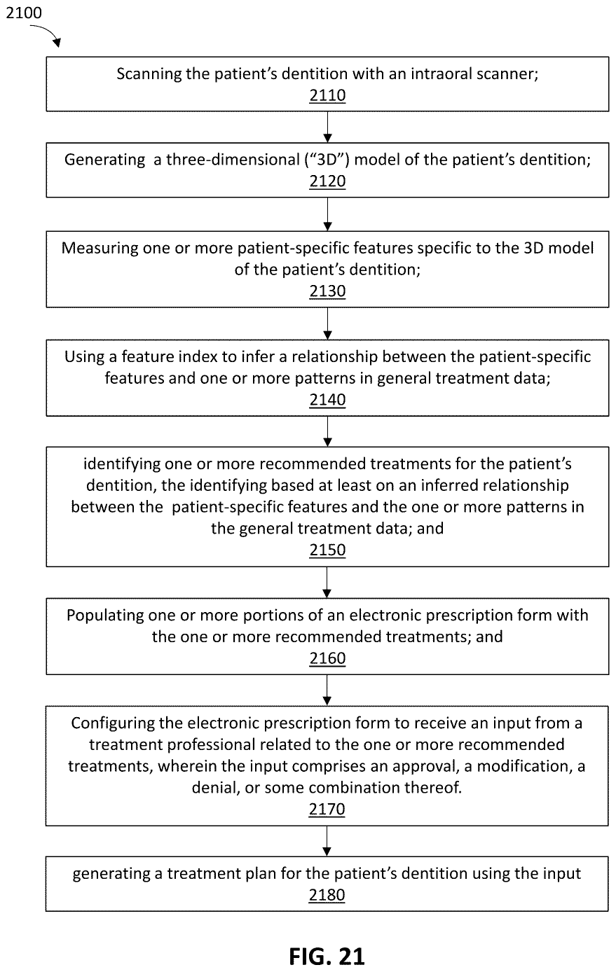

FIG. 21 schematically illustrates another example of a method 2100 as described herein. For example this method (2000) illustrates a sequence of operations for generating a treatment plan for a patient's dentition using digital scanning and data-driven analysis. The process may include receiving and/or scanning the patient's dentition with an intraoral scanner 2110. This scanning operation may capture a high-resolution digital representation of the patient's teeth and oral structures, eliminating the need for traditional physical impressions. A three-dimensional (“3D”) model of the patient's dentition may be generated (or received, as described above) from the scan data 2120. The 3D model may provide an accurate spatial representation of the dentition, enabling detailed visualization and analysis.

One or more patient-specific features may be estimated and/or measured from the 3D model 2130. Examples of features may include tooth alignment, spacing, occlusion, arch form, etc., or other as described above. A feature index may be utilized to infer a relationship between the patient-specific features and one or more patterns in general treatment data 2140. The feature index may comprise a database or algorithm trained on historical treatment outcomes, enabling predictive analysis. Based on the inferred relationship, one or more recommended treatments for the patient's dentition may be identified 2150. The identification process may rely on correlations between the patient-specific features and patterns observed in general treatment data. One or more portions of an electronic prescription form may be populated with the recommended treatments 2160. This step may facilitate digital documentation and streamlines the treatment planning workflow. The electronic prescription form may be configured to receive input from a treatment professional 2170. The input may include approval, modification, denial, or a combination thereof, allowing for professional oversight and customization of the treatment plan.

Alternatively, in some cases a treatment plan for the patient's dentition may be generated 2180 using the input provided by the treatment professional. The finalized plan may include procedural steps, timelines, and associated resources for implementing the recommended treatments. In some cases the population of the prescription form may be the output (and no further treatment plan output 2180 may need to be provided).

All publications and patent applications mentioned in this specification are herein incorporated by reference in their entirety to the same extent as if each individual publication or patent application was specifically and individually indicated to be incorporated by reference. Furthermore, it should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein. Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method, the method comprising:
scanning a patient's dentition with an intraoral scanner;
generating a three-dimensional (“3D”) model of the patient's dentition;
measuring one or more patient-specific features specific to the 3D model of the patient's dentition;
using a feature index to infer a relationship between the patient-specific features and one or more patterns in general treatment data;
identifying one or more recommended treatments for the patient's dentition, the identifying based at least on an inferred relationship between the patient-specific features and the one or more patterns in the general treatment data; and
outputting the one or more recommended treatments.

2. The method of claim 1, wherein using the using the feature index to infer the relationship between the patient-specific features and the one or more patterns in the general treatment data comprises predicting one or more discrete treatment classifications for the patient's dentition using the feature index.

3. The method of claim 1, wherein:
using the feature index to infer the relationship between the patient-specific features and the one or more patterns in the general treatment data comprises predicting one or more discrete treatment classifications for the patient's dentition using the feature index; and
predicting the one or more discrete treatment classifications comprises using a decision tree to classify the patient's dentition using the feature index.

4. The method of claim 1, wherein the general treatment data comprises real treatment data, synthetic treatment data, or some combination thereof.

5. The method of claim 1, wherein the general treatment data is organized in a tabular format with a first data dimension representing individual instances of data and a second data dimension representing one or more treatment planning attributes to associate with the individual instances of data.

6. The method of claim 1, wherein the method is executed while scanning the patient's dentition.

7. The method of claim 1, wherein outputting the one or more recommended treatments comprises displaying the one or more recommended treatments on an intraoral scanner, a display of a treatment professional system, a display of a doctor system, a display of a treatment planning system, or some combination thereof.

8. The method of claim 1, wherein outputting the recommended treatment comprises displaying a plurality of treatment recommendations for a given dental condition.

9. The method of claim 1, wherein outputting the one or more recommended treatments comprises providing the one or more recommended treatments to an electronic prescription form.

10. The method of claim 1, wherein:
outputting the one or more recommended treatments comprises populating one or more portions of an electronic prescription form with the one or more recommended treatments; and
the method further comprises configuring the electronic prescription form to receive an input from a treatment professional related to the one or more recommended treatments.

11. The method of claim 1, wherein:
outputting the one or more recommended treatments comprises populating one or more portions of an electronic prescription form with the one or more recommended treatments; and
the method further comprises configuring the electronic prescription form to receive an input from a treatment professional related to treatments other than the one or more recommended treatments.

12. The method of claim 1, wherein outputting the one or more recommended treatments comprises using the one or more recommended treatments to complete at least a portion of an electronic prescription form, receiving input comprising modifications, approvals, or some combination thereof to the electronic prescription form, and processing the input and/or generating a treatment plan for the patient's dentition using the input.

13. The method of claim 1, wherein outputting the one or more recommended treatments comprises translating the one or more recommended treatments to a domain-specific treatment protocol and using one or more translated recommended treatments translated to a domain-specific treatment protocol to complete at least a portion of an electronic prescription form.

14. The method of claim 1, wherein outputting the one or more recommended treatments comprises using the one or more recommended treatments to complete at least a portion of an electronic prescription form, and the portion comprises:
a transverse correction field displaying recommendations for arch expansion, palatal expansion, patient-specific transverse expansion parameters or some combination thereof;
a mesial-distal correction field displaying options for mesial-distal correction, patient-specific mesial-distal correction parameters, or some combination thereof;
an appliance field displaying recommendations for appliances to achieve the one or more recommended treatments;
or some combination thereof.

15. The method of claim 1, further comprising identifying one or more dental appliances to implement the one or more recommended treatments.

16. A system comprising:
one or more processors;
a memory storing computer-program instructions, that, when executed by the one or more processors, perform a computer-implemented method comprising:
scanning a patient's dentition with an intraoral scanner;
generating a three-dimensional (“3D”) model of the patient's dentition;
measuring one or more patient-specific features specific to the 3D model of the patient's dentition;
using a feature index to infer a relationship between the patient-specific features and one or more patterns in general treatment data;
identifying one or more recommended treatments for the patient's dentition, the identifying based at least on an inferred relationship between the patient-specific features and the one or more patterns in the general treatment data; and
outputting the one or more recommended treatments.

17. A method of determining, one or more interventions while scanning a patient's dentition, the method comprising:
scanning the patient's dentition with an intraoral scanner;
generating a three-dimensional (“3D”) model of the patient's dentition;
measuring one or more features of the 3D model of the patient's dentition;
calculating a recommended treatment of one or more of the patient's teeth based at least on the measured one or more features and a feature index based on patient-specific data; and
outputting the recommended treatment.

18. The method of claim 17, further comprising providing one or more dental appliances based on the recommended treatment.

19. The method of claim 17, wherein outputting comprising visually presenting the recommended treatment on a display in communication with the intraoral scanner.

20. The method of claim 19, wherein visually presenting the recommended treatment comprises visually presenting at least one of a recommended lateral expansion, a recommended Anterior-Posterior (A-P) movement, or a recommended vertical movement.

21. The method of claim 19, wherein visually presenting the recommended treatment comprises visually presenting a one or more factors for the recommended treatment.
